(19) United States
(12) Patent Application Publication
(10) Pub. No.: US 2011/0178702 A1
(43) Pub. Date: Jul. 21, 2011

(54) OPTIMUM TRAVEL TIMES

(75) Inventors: Kristian Lassesson, Lund (SE); Eva Madeleine Andersson, Lund (SE); Sven-Olof Karlsson, Lund (SE)

(73) Assignee: SONY ERICSSON MOBILE COMMUNICATIONS AB, Lund (SE)

(21) Appl. No.: 12/690,216

(22) Filed: Jan. 20, 2010

(51) Int. Cl. G01C 21/36

(52) U.S. Cl. 701/207; 701/200

(57) ABSTRACT

A device may receive a request, from a user device, to determine optimal starting times for a trip. In addition, the device may obtain a destination address and a starting address of the trip from the request, identify a first route based on the destination address and the starting address, and determine the optimal starting times based on different allowable starting times and travel data, the determined optimal starting times providing for a shortest estimated travel time on the first route. Further, the device may send a description of the first route and the determined optimal starting time to the user device.

### BACKGROUND

Traffic varies from day to day. For example, a driver that encounters congested traffic one day at 10:00 a.m. may find, at the same time on the same road the next day, relatively light traffic. Weather conditions, road constructions, accidents, police and ambulance activities, day-of-the-week, seasons, and/or other factors may affect traffic patterns from day-to-day, hour-to-hour, and minute-to-minute.

### SUMMARY

According to one aspect, a method may include receiving a request, from a user device, to determine optimal starting times for a trip. In addition, the method may include obtaining a destination address and a starting address of the trip from the request identifying a first route based on the destination address and the starting address, and determining the optimal starting times based on different allowable starting times and travel data, the determined optimal starting times providing for a shortest estimated travel time on the first route. The method may further include sending a description of the first route and the determined optimal starting time to the user device.

Additionally, determining the optimal starting times may include identifying portions of the route, obtaining traffic information for each of the portions, determining a travel time for each of the portions based on the traffic information, and calculating a total travel time for the route based on the determined travel times for the portions.

Additionally, obtaining the traffic information may include performing a lookup of the traffic information in a database for each of the portions, or requesting and receiving the traffic information for the portions from a remote device.

Additionally, performing the lookup may include performing a lookup of past speeds of vehicles on one of the portions based on time information, weather information, and locality information.

Additionally, performing the lookup of past speeds of vehicles on the portion based on time information may include performing a lookup of past speeds of vehicles on the portion based on time of day and none or more of: day of week, day of month, or month of year.

Additionally, the method may further include receiving traffic data from user devices and storing the traffic data, weather information, and locality information.

Additionally, the method may further include determining an alternate route when the calculated total time exceeds an average travel time by a particular amount, and determining, based on other travel data and the allowable starting times, a starting time that provides a shortest estimated travel time on the alternate route.

Additionally, the travel data may include past location, time, and speed information for the user device.

Additionally, determining travel time for each of the portions based on the traffic information may include scheduling a departure time for the trip.

According to another aspect, a device may include a network interface for communicating with a remote device and a processor. The processor may be configured to receive user input that specifies a time window for starting a trip and communicate, to the remote device, a request for information pertaining to the trip. In addition, the processor may be configured to receive the information from the remote device, and identify, based on the information, a starting time that is in the time window and provides for a shortest estimated travel time. Further, the processor may be configured to output, to the user, information conveying the starting time.

Additionally, the time window may include a time window for completing the trip.

Additionally, the device may include a cell phone or a personal digital assistant.

Additionally, the device may further include a navigational component configured to obtain locations of the device.

Additionally, the processor may be further configured to send a description of the locations of the device to a traffic device when an average traveling speed of the device exceeds a particular threshold.

Additionally, the processor may be further configured to send a description of the locations of the device from within a moving vehicle.

Additionally, the navigational components may include at least one of a global positioning system (GPS) receiver; an accelerometer; a magnetometer; or a gyroscope; a component for locating the device based on Wi-Fi; or a component for locating the device based on Global System for Mobile Communications (GSM).

Additionally, the processor may be further configured to determine an alternate route when a current estimated time of travel exceeds an average travel time by a particular amount.

Additionally, the processor may be further configured to obtain past travel times for the route from the remote device.

Additionally, the information may include travel data or a description of the starting time and a travel time associated with the starting time.

According to yet another aspect, a device may include a processor configured to receive, from a user device, a request to determine optimal starting times for a trip. The processor may be further configured to identify a route that is associated with the trip and estimate, based on travel data and different allowable starting times specified in the request, a shortest travel time. In addition, the processor may be further configured to send a description of a starting time that is associated with the shortest travel time to the user device.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a diagram of an exemplary network in which concepts described herein may be implemented;

FIGS. 2A and 2B are front and rear views of an exemplary user device of FIG. 1;

FIG. 3 is a block diagram of exemplary components of network device of FIG. 1;

FIG. 4 is a block diagram of exemplary functional components of the user device of FIG. 1;

FIG. 5 is a diagram of an exemplary graphical user interface (GUI) of the travel time logic of FIG. 4;

FIG. 6 is a block diagram of exemplary functional components of the server device of FIG. 1;

FIG. 7 is a flow diagram of an exemplary process associated with the user device of FIG. 1;

FIG. 8 is a flow diagram of an exemplary process associated with the server device of FIG. 1; and

FIG. 9 illustrates an example associated with the processes of FIGS. 7 and 8.

### DETAILED DESCRIPTION

The following detailed description refers to the accompanying drawings. The same reference numbers in different drawings may identify the same or similar elements. As used herein, the term “travel data” or “travel information” refers to data that is associated with a trip or journey having a starting location and an ending location. Travel data, for example, may include information pertaining to time (e.g., time of day, day of week, month, and season), geographical location (e.g., longitude and latitude, United States National Grid (USNG) coordinate, etc.), environment (e.g., weather conditions, presence of constructions, police cars, ambulance, etc.), traffic information (e.g., number of cars per square meter), locality (e.g., number of traffic lights per distance, zoning (e.g., city)), etc.

In the following, a system may inform a user of optimal times and/or paths for traveling. To determine the optimal times/paths, a user device may obtain current and past travel data from a communication network or from a local storage. By using the travel data, the user device may estimate the amount of travel time for each of different starting times and paths. Furthermore, based on user preference, the user device may inform the user of the best starting time and/or path (e.g., the starting time and/or the path that minimizes the travel time, a path that the user prefers, etc.). When the user is traveling, the user device may continue to provide information for navigating an optimum route to a destination.

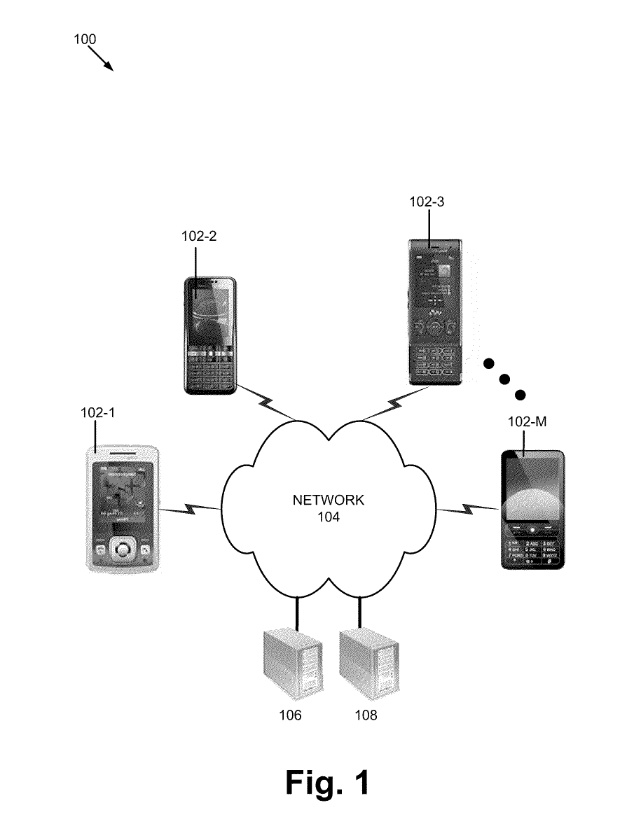

FIG. 1 is a diagram of an exemplary network 100 in which the concepts described herein may be implemented. As shown, network 100 may include user devices 102-1 through 102-M (collectively referred to as “user devices 102” and individually as “user device 102-x”), network 104, a server device 106, and traffic data provider 108.

User device 102-x may generate travel data. In some implementations, user device 102-x may be positioned within a vehicle, and may communicate travel information to another device in real time, such as server device 106 or traffic data provider 108. In other implementations, user device may locally store collected travel data, and upload the data to server device 106 at scheduled moments.

In addition, in one implementation, user device 102-x may obtain travel data from server device 106 or traffic data provider 108. User device 102-x may use the obtained travel data to provide the optimal starting times and/or paths to the user. In a different implementation, user device 102-x may show the optimal starting times and/or paths described by server device 106-x to the user.

Network 104 may include a cellular network, a public switched telephone network (PSTN), a local area network (LAN), a wide area network (WAN), a wireless LAN, a metropolitan area network (MAN), a Long Term Evolution (LTE) network, an intranet, the Internet, a satellite-based network, a fiber-optic network (e.g., passive optical networks (PONs)), an ad hoc network, any other network, or a combination of networks. Devices that are shown in FIG. 1 may connect to network 104 via wireless, wired, or optical communication links. In addition, network 104 may allow any of devices 102, 106 and 108 to communicate with any other device 102-x, 106, or 108.

Server device 106 may receive travel data from network devices (e.g., user devices 102, traffic data provider 108, etc.) and maintain the travel data in a database. In addition, server device 106 may receive requests for travel data from other devices, such as user device 102-x, or alternatively, a request to determine optimal times/paths for traveling. In response to a user request, server device 106-x may retrieve the requested travel data, or determine the optimal times/paths and convey a description thereof to user device 102-x.

Traffic data provider 108 may collect current traffic information from user devices 102 that are located in vehicles (e.g., cars) and provide the information to other devices, such as user devices 102 or server device 106. The traffic information from user device 102-x may describe a location (e.g., coordinates, position information, etc.) velocity, and/or time (e.g., the time at which the location is identified). In some implementations, traffic data provider 108 may process the traffic information to determine how much time a vehicle may spend on a particular route. An example of traffic data provider 108 may include a network device associated with Mobile Millenium project.

Depending on the implementation, network 100 may include additional, fewer, or different devices than the ones illustrated in FIG. 1. For example, in some implementations, network 100 may include hundreds, thousands, or more user devices, additional server devices, and/or traffic data providers.

In another example, server device 106 may not only store and/or retrieve travel data, but also process requests to determine optimal travel paths and/or a travel time within a specified time window. In a different implementation, server device 106 may off-load such processing to user devices 102. That is, user device 102-x may obtain travel data from server device 106, and use the obtained travel data to determine the optimal times/paths for traveling.

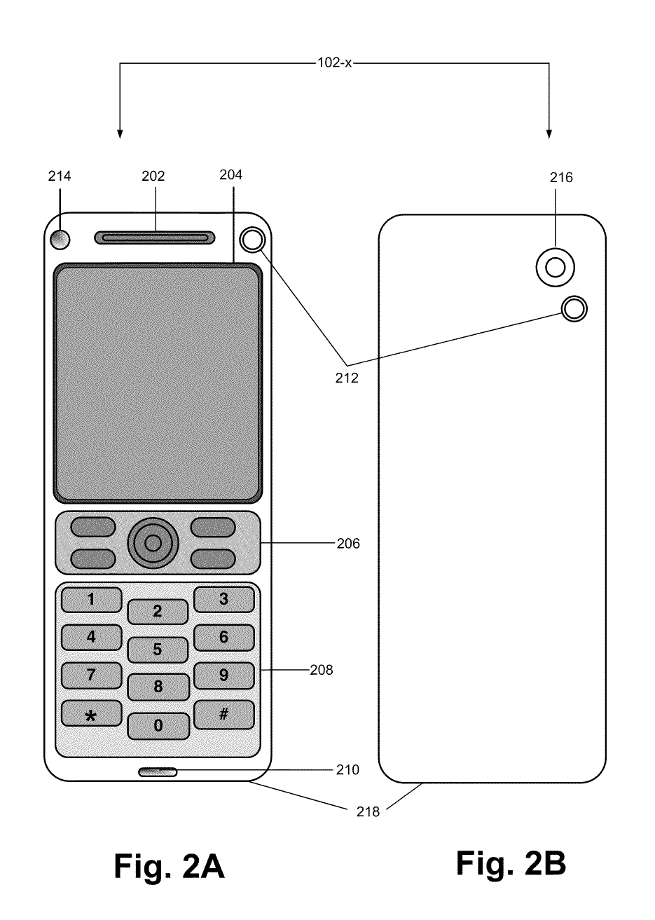

FIGS. 2A and 2B are front and rear views, respectively, of user device 102-x. User device 102-x may include any of the following devices with self-locating or Global Positioning System (GPS) receiver capabilities: a mobile telephone; a cell phone; a personal communications system (PCS) terminal that may combine a cellular radiotelephone with data processing, facsimile, and/or data communications capabilities; a laptop; a personal digital assistant (PDA) that can include a telephone; a gaming device or console; a peripheral (e.g., wireless headphone); a digital camera; or another type of computational or communication device. Depending on the implementation, user device 102-x may use Universal Mobile Telecommunications system (UMTS) network, Global System for Mobile Telecommunications (GSM) network, etc.

In this implementation, user device 102-x may take the form of a portable phone (e.g., a cell phone). As shown in FIGS. 2A and 2B, user device 102-x may include a speaker 202, a display 204, control buttons 206, a keypad 208, a microphone 210, sensors 212, a front camera 214, a rear camera 216, and a housing 218. Speaker 202 may provide audible information to a user of user device 102-x. Display 204 may provide visual information to the user, such as an image of a caller, video images received via rear camera 216 (e.g., road scenes), or pictures. In some implementations, display 204 may include a touch screen via which user device 102-x receives user input.

Control buttons 206 may permit the user to interact with user device 102-x to cause user device 102-x to perform one or more operations, such as place or receive a telephone call, record videos of a trip, etc. Keypad 208 may include a standard telephone keypad. Microphone 210 may receive audible information from the user and/or the surroundings. Sensors 212 may collect and provide, to user device 102-x, information (e.g., acoustic, infrared, etc.) that is used to aid the user in capturing images or in providing other types of information (e.g., a distance between a user and user device 202-x).

Front camera 214 and rear camera 216 may enable a user to view, capture and store images (e.g., pictures, video clips) of a subject in/at front/back of user device 102-x. Front camera 214 may be separate from rear camera 216 that is located on the back of user device 102-x. Housing 218 may provide a casing for components of user device 102-x and may protect the components from outside elements.

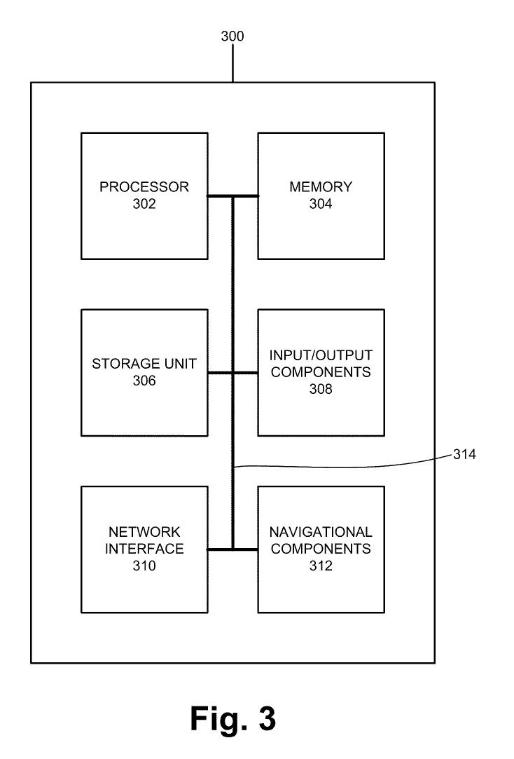

FIG. 3 is a block diagram of exemplary components of a network device 300, which may represent any of devices 102 or 106. As shown in FIG. 3, network device 300 may include a processor 302, a memory 304, storage unit 306, input/output components 308, a network interface 310, navigational components 312, and a communication path 314. In different implementations, network device 300 may include additional, fewer, or different components than the ones illustrated in FIG. 3. For example, network device 300 may include additional network interfaces, such as interfaces for receiving and sending data packets.

Processor 302 may include a processor, a microprocessor, an Application Specific Integrated Circuit (ASIC), a Field Programmable Gate Array (FPGA), and/or other processing logic (e.g., audio/video processor) capable of processing information and/or controlling network device 300. Memory 304 may include static memory, such as read only memory (ROM), and/or dynamic memory, such as random access memory (RAM), or onboard cache, for storing data and machine-readable instructions. Storage unit 306 may include storage devices, such as a floppy disk, CD ROM, CD read/write (R/W) disc, and/or flash memory, as well as other types of storage devices.

Input/output components 308 may include a display screen (e.g., display 204), a keyboard, a mouse, a speaker, a microphone, a Digital Video Disk (DVD) writer, a DVD reader, Universal Serial Bus (USB) port, and/or other types of components for converting physical events or phenomena to and/or from digital signals that pertain to network device 300.

Network interface 310 may include a transceiver that enables network device 300 to communicate with other devices and/or systems. For example, network interface 408 may communicate via a network, such as the Internet, a terrestrial wireless network (e.g., a WLAN), a cellular network, a satellite-based network, a wireless personal area network (WPAN), etc. Additionally or alternatively, network interface 408 may include a modem, an Ethernet interface to a LAN, and/or an interface/connection for connecting network device 300 to other devices (e.g., a Bluetooth interface).

Navigational components 312 may provide position, velocity, acceleration, deceleration (e.g., retardation), and/or orientation information (e.g., north, south, east, west, etc.) to a user or other components of network device 300. Examples of navigational components include GPS receivers, a miniature or micro accelerometer and/or gyroscope, a magnetometer (e.g., digital compass), components for determining locations of network device 300 based on Wi-Fi and/or GSM network/systems, etc. Communication path 314 may provide an interface through which components of network device 300 can communicate with one another.

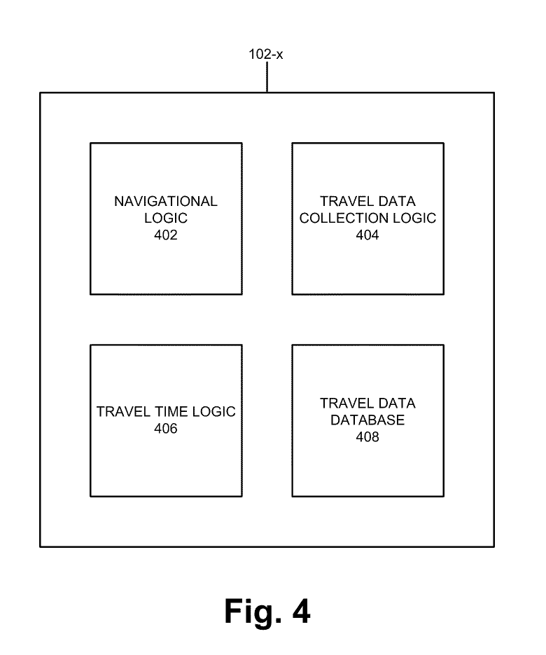

FIG. 4 is a block diagram of exemplary functional components of user device 102-x. As shown, user device 102-x may include navigational logic 402, travel data collection logic 404, travel time logic 406, and travel data database 408. Depending on the implementation, user device 102-x may include additional, fewer, or different functional components than those illustrated in FIG. 4. For example, in one implementation, user device 102-x may include an operating system, document application, game application, etc. In a different implementation, navigational logic 402 and travel data collection logic 404 may be integrated as a single functional component.

Navigational logic 402 may obtain location/directional/velocity information, from, for example, navigational components 310 (e.g., a GPS receiver, gyroscope, magnetometer, etc.), and provide the information to a user or other components, such as travel data collection logic 406. In some implementations, navigational logic 402 may include a user interface via which navigational logic 402 receives input that identifies, for example, a starting location and/or an ending location of a trip.

In a different implementation, navigational logic 402 may determine a destination based on user locations over a period of time. For example, assume that a user walks to her garage every morning, and drives to her office. When the user begins to walk toward the garage, navigational logic 402 may determine the path that the user has traveled within a particular period of time (e.g., 1 min), and infer a longer route that includes the path which the user usually travels. Optionally, navigational logic 402 may query the user whether the inferred destination is correct (e.g., display a question via a display screen 204 or ask the question via a speech synthesizer, etc.).

Travel data collection logic 404 may obtain location and time information from navigational logic 402, store the collected data in travel data database 408, and/or transmit the collected data to another device, such as server device 106 or traffic data provider 108.

In one implementation, travel data collection logic 404 may begin and end collecting data when the user begins and ends a trip, respectively. Alternatively, travel data collection logic 404 may automatically begin and end collecting data based a user's travel speed (e.g., user is traveling faster than a walking speed (e.g., 10 kilometers/hour)).

Travel time logic 406 may receive input describing a time window, starting location, and destination from a user, and provide an estimated travel time and/or alternate travel paths based on data that is stored at travel data database 408 and/or data received from server device 106/traffic data provider 108.

Depending on the implementation, travel time logic 406 may obtain/estimate a travel time in different ways. For example, in one implementation, travel time logic 406 may send a request for travel data to server device 106 and/or traffic data provider 108. The request may include information describing the starting location of a trip, destination, a time window, and/or additional information indicating whether server device 106/traffic data provider 108 is to match the data to specific conditions that may affect traffic (e.g., day of week, weather condition, presence of construction, ambulance, etc.). In response, server device 106 and/or traffic data provider 108 may send, for different starting times of the trip, a description of one or more routes for reaching the destination from the starting location and traffic data associated with the routes. Based on the description, travel time logic 406 may determine, for each of the routes, estimated travel times for a number of different starting times.

For example, assume that a time window spans 8:00 a.m. to 8:30 a.m., and there are 3 paths to a destination. For each of the paths, travel time logic 406 may determine travel times, where each travel time corresponds to a particular starting time (e.g., 8:00 a.m., 8:05 a.m., 8:10 a.m., etc.). Once the optimum path/time is determined, travel time logic 406 may convey the information to the user via input/output components 308 (e.g., speaker 202, display 204, etc.). In some implementations, as the user travels toward the destination, travel time logic 406 may continuously obtain updated, optimal path/travel times based on current traffic data, and allow the user to select different routes based on evolving traffic patterns and/or changing road conditions.

In a different implementation, instead of determining the optimal routes/travel times, travel time logic 406 may request server device 106 and/or traffic data provider 108 to provide a description of the optimal routes/travel times. In such an implementation, server device 106 and/or traffic data provider 108 may determine the paths and/or the travel times and convey the information to travel time logic 406.

In another implementation, travel time logic 406 may receive optimal travel time for a particular route (e.g., a route that the user typically travels) based on current traffic information. In such an implementation, when travel time logic 406 determines that a determined optimal travel time for the route may take longer than the average travel time (e.g., by more than 20%, 5 minutes, etc.), travel time logic 406 may identify an alternate route that may allow the user to take less time to reach the destination.

Travel data database 408 may include records of locations in a trip, times associated with the locations, weather conditions received or obtained from a network, etc.

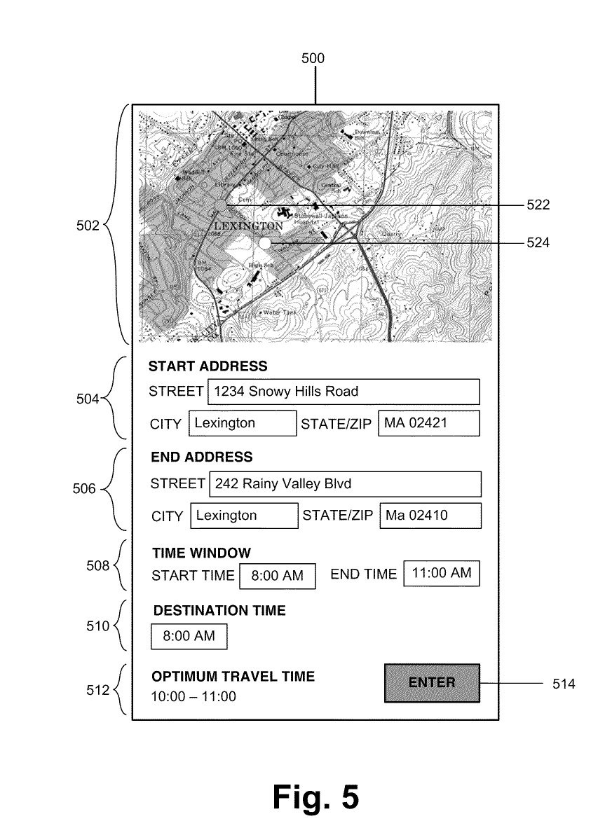

FIG. 5 is a diagram of an exemplary graphical user interface (GUI) window 500 via which travel time logic 406 may receive user input. In other implementations, travel time logic 406 may receive user input via other components (e.g., microphone 210). As shown, GUI window 500 may include a map pane 502, start address pane 504, end address pane 506, time window pane 508, destination time pane 510, optimum travel time pane 512, and enter button 514. Depending on the implementation, GUI window 500 may include additional, fewer, or different components than those illustrated in FIG. 5.

Map pane 502 may display a map of an area surrounding a route from a starting point 522 to a destination 524. In one implementation, when travel time logic 406 receives information/data from server device 106 and/or traffic data provider 108, map pane 502 may also display one or more routes that the user can take to reach destination 524 (e.g., highlight additional routes).

Start address pane 504 may receive a starting address of a trip from the user. In a different implementation or configuration, travel time logic 406 may automatically obtain the current location of user device 102-x and fill input fields of start address pane 504.

End address pane 506 may receive a destination address of the trip from the user. In a different implementation or configuration, travel time logic 406 may infer the destination address based on time, user's current location, initial direction of movement over a particular period of time, and/or past travel data.

Time window pane 508 may receive user input specifying a time window during which the user is to travel or start traveling. Destination time pane 510 may receive user input specifying a time by which the user is to arrive at the destination.

Optimum travel time pane 512 may display the optimum travel time that travel time logic 406 determines or obtains from another device (e.g., server device 106). Enter button 514 may cause travel time logic 406 to obtain or determine the optimal routes/travel times. Map pane 502 and optimum travel time pane 512 may display the determined routes/travel times.

In a different implementation, GUI window 500 may provide GUI components for obtaining additional information, such as the amount of time that the user took on a previous trip to the same end address. This may allow the user to review how much time the user could have saved, by leaving a starting location at different times. In another implementation, GUI window 500 may provide GUI components for selecting whether the travel times is to be determined based on the current traffic data (e.g., live data) or past traffic data.

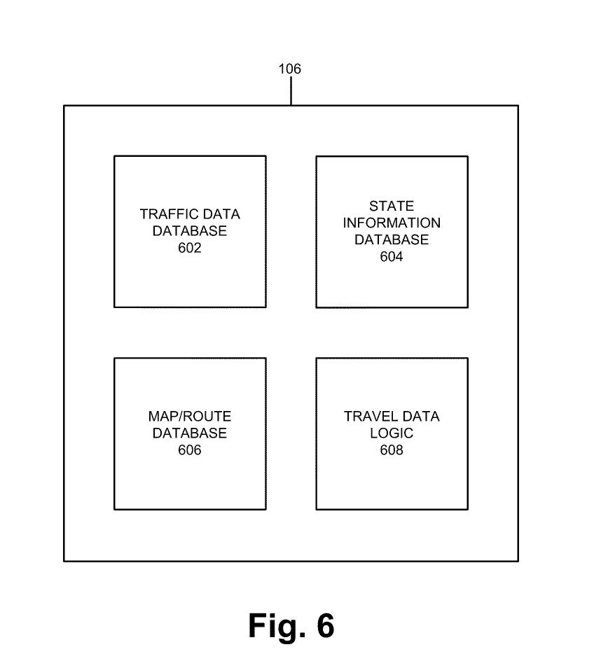

FIG. 6 is a block diagram of exemplary functional components of server device 106. As shown, server device 106 may include of traffic data database 602, state information database 604, map/route database 606, and travel data server 608. Depending on the implementation, server device 106 may include additional, fewer, or different components than those illustrated in FIG. 6. For example, in some implementations, traffic data database 602 and state information database 602 may be aggregated into a single database. In other implementations, server device 106 may not include traffic data database 602, and may obtain traffic data from another device, such as traffic data provider 106.

Traffic data database 602 may include records of locations (e.g., longitude and latitude), time (e.g., 8:00 a.m. on Saturday, Jan. 1, 2010) and speeds (e.g., 60 kilometers per hour) of each of user devices 102 in vehicles. State information database 604 may include information pertaining to environment (e.g., weather conditions, road conditions, presence of a police vehicle on a particular route, etc.) at a particular time and location.

Map/route database 606 may include maps and/or route information. The route information may be used to determine a route or route segments (e.g., components of a route) between a starting point and an end point of a trip.

Travel data logic 608 may receive traffic data from user devices 102 and maintain the traffic data in traffic data database 602. In addition, travel data logic 608 may obtain, when available, other travel information, such as information related to environment (e.g., weather conditions, presence of constructions, police cars, ambulance, etc.), locality (e.g., number of traffic lights per distance, zoning (e.g., city)), etc., and store such information in state information database 604. In some implementations, travel data logic 608 may obtain the traffic information from traffic data provider 108 (e.g., number of cars per square meter, number of cars passing a given point per unit time, etc.), etc.

In addition, travel data logic 608 may receive requests for travel data from other devices, such as user devices 102, or alternatively, may receive requests to determine optimal times/paths for traveling. In response to a user request, travel data logic 608 may retrieve the requested travel data, or determine the optimal times/paths and convey a description thereof to user device 102-x.

In a different implementation, when a large number of user devices 102 requests information from server device 106, travel data logic 608 may use travel data to not only determine optimal times/path, but to schedule the departure times for each of user devices 102. Consequently, travel data logic 608 may request some user devices 102 to depart at certain time windows via particular paths, and other user devices 102 leave at different time windows via other paths, in order to evenly distribute traffic over time and space. That is, travel data logic 608 may aid in controlling traffic patterns to globally optimize travel times for multitude of vehicles in specified regions (e.g., city).

### Exemplary Processes

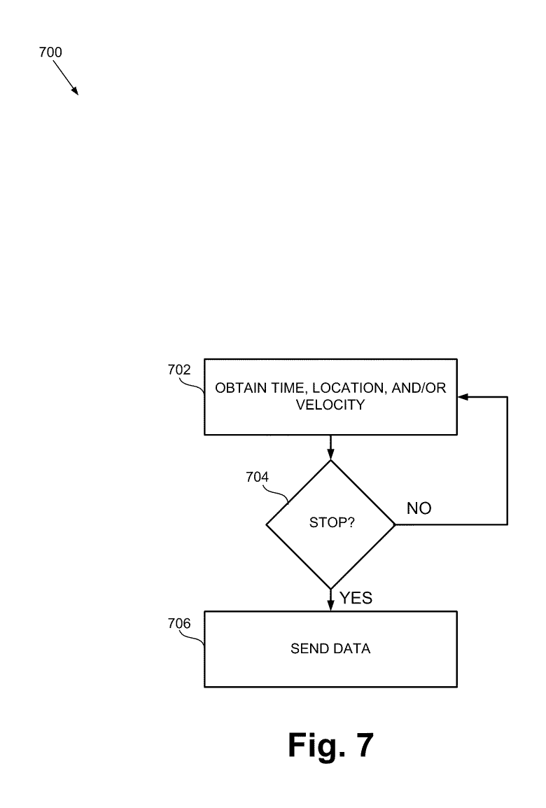

FIG. 7 is a flow diagram of an exemplary process associated with user device 102-x. Assume that user device 102-x is positioned inside a vehicle, and the vehicle is traveling on a road.

User device 102-x may obtain information describing a current time and location (block 702). For example, user device 102-x may obtain its coordinates from navigational components 312 and time (e.g., Saturday, January 1^{st}, 11:14:50 a.m.) from an internal clock.

User device 102-x may determine whether user device 102-x is to continue to gather the location and time information (block 704). For example, in some implementations, user device 102-x may include a component (e.g., a piece of software or hardware) that instructs user device 102-x to gather location and time information based on a time window, locations, or speeds. If the current time is outside of the window, user device 102-x is outside a specified area or the speed of user device 102-x is below a particular threshold (block 704—YES), user device 102-x may stop obtaining time, location, and/or velocity information. Otherwise, user device 102-x may continue to obtain location, time, and/or velocity information (block 702).

In some implementations, user device 102-x may locally cache the obtained time, location, and/or velocity information and send the cached information to server device 106 (block 706), rather than sending the information piecemeal. The obtained information may also be stored locally.

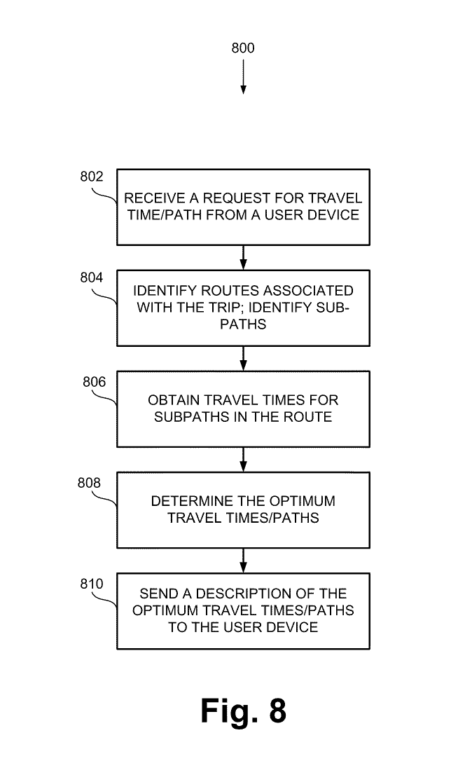

FIG. 8 is a flow diagram of an exemplary process associated with server device 106. Assume that user device 102-x has sent a request for an optimum travel time to server device 102-x. In addition, assume that the request indicates whether the server is to use the past or current traffic data.

Server device 106 may receive the request for travel time/path from user device 102-x (block 802). The request may include information relating a starting address or location of user device 102-x, a destination address or location, an identifier that is associated with user device 102-x, and a time window during which the user is to travel.

Server device 106 may identify a route that is associated with the trip (block 804). Based on the starting location/address and destination location/address provided in the request, server device 106 may consult traffic data database 602 to determine a usual route that the user takes and/or map/route database 606 to determine one or more routes for the trip.

In some implementations, user device 102-x may send, in addition to or within the request, information describing a series of recent locations of user device 102-x without the destination address. In such an instance, server device 106 may infer the user's destination based on the past trips and current location. For example, assume that the user leaves for her office on weekday mornings at 8:00 a.m. +/−5 min. Based on the user's location (e.g., at her home), the time, and user's past trips, server device 106 may infer the user's office as the destination. Depending on the configuration, subsequently, user device 102-x may request the user to verify the inferred destination.

For each route that is identified at block 802, server device 106 may identify sub-paths (block 804). For example, assume that on rainy Monday, Jane, a user, can leave her work office 8:15 a.m. at the earliest and must arrive at the office by 9:00 a.m. In addition, assume that the route consists of a portion of Main Street, Rolling Road, and Park Lane. Server device 106 may identify each of the portions based on the starting and destination addresses (e.g., starting point and end point for each street, road, thoroughfare, etc.).

Server device 106 may determine travel times for each of the sub-paths (block 806). Continuing with the previous example, server device 106 may perform lookups in traffic data database 602 to determine, on rainy Monday, traveling on the Main Street at 8:15 a.m., 8:20 a.m., 8:25 a.m., 8:30 a.m., and 8:35 a.m. usually takes 5, 7, 9, 10, and 10 minutes, respectively; Rolling Road at 8:20 a.m., 8:27 a.m., 8:34 a.m., 8:40 a.m. and 8:45 a.m. takes 7, 9, 11, 10, and 8 minutes, respectively; and Park Lane at 8:27 a.m., 8:36 a.m., 8:45 a.m., 8:50 a.m., 8:53 a.m. takes 3, 4, 4, 3, and 2 minutes, respectively. In some implementations where pertinent traffic data and state data is available, server device 106 may condition the lookups based on additional information, such as the current month, road conditions, etc.

In determining an average time that a vehicle may spend on a portion of a road, server device 106 may determine an average time that different vehicles has spent on traveling the portion. In some instances, sufficient data may not be available (e.g., when server device 106 is attempting to estimate the travel time based on current traffic/travel data), server device 106 may simply use an average velocity of vehicles at different points on the portion of the road.

Server device 106 may determine the shortest travel time (block 808). Continuing with the previous example, server device 106 calculates that if Jane leaves for her office at 8:15 a.m., 8:20 a.m., 8:25 a.m., 8:30 a.m., or 8:35 a.m., Jane's trip may take total of 15 minutes (5+7+3=15), 20 minutes (7+9+4=20), 24 minutes (9+11+4=24), 22 minutes (10+10+3=23), and 20 minutes (10+8+2), respectively. Server device 106 may determine that Jane leaving for her office at 8:15 a.m. and 8:35 a.m. results in the shortest travel times, which are 15 minutes, and 20 minutes, respectively.

Server device 106 may send a description of the shortest travel times to user device 102-x (block 810). Continuing with the preceding example, server device 106 sends information relating the shortest travel times to user device 102-x, and user device 102-x conveys, to Jane, that Jane may take 15 and 20 minutes if Jane leaves for her office at 8:15 a.m. and 8:35 a.m., respectively. Accordingly, Jane decides to leave for her office at 8:35 a.m.

In a different implementation, server device 106 may first determine an optimum travel time for a given path (e.g., a path that the user usually takes) based on current traffic data. When the travel time exceeds the average travel time by a predetermined amount (e.g., 10%, 5 minutes, etc.), server device 106 may identify different routes and determine travel times for the routes.

In some implementations, when a travel time for an entire route is available in traffic data database 602 (e.g., past travel times of user device 102-x for the route is stored in traffic data database 602), server device 106 may obtain the travel time for the entire route via a lookup in traffic data database 602, without identifying sub-paths and obtaining travel times for the sub-paths.

As the user' travels to her the office, via either her usual route or an alternate route suggested by user device 102-x/server device 106, user device 102-x/server device 106 may log and store travel/traffic data in travel data database 408/traffic data database 602.

### Example

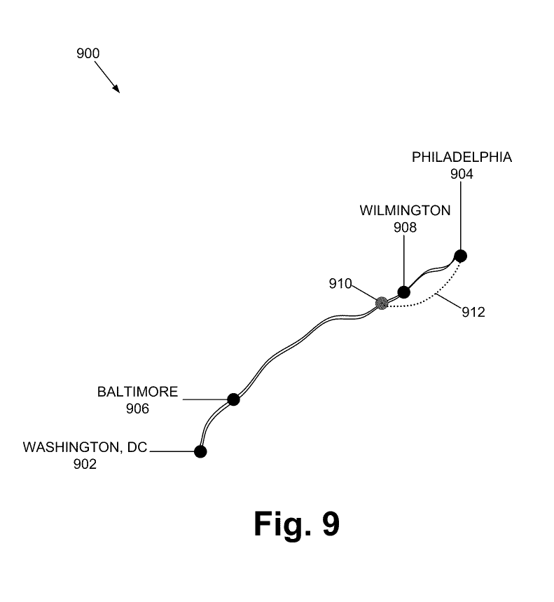

FIG. 9 illustrates an example associated with the processes of FIGS. 7 and 8. More specifically, FIG. 9 shows a route from Washington, D.C. 902 to Philadelphia 904. Assume that Madeleine, Kristian, and Sven-Olof are ready to begin a road trip from Washington, D.C. 902 to Philadelphia 904. As shown in FIG. 9, a route 900 passes through or near Baltimore 906 and Wilmington 908.

Before starting on the trip, Madeleine inputs the starting location, the destination, and a time window of 6:00 a.m. and 4:00 p.m. into user device 102-x. In response, user device 102-x sends a query to server device 106, requesting server device 106 to determine the optimum time to start the trip. In response, server device 106 determines that the optimum times for starting the trip is 10:15 a.m. based on the current traffic data.

Madeleine, Kristian, and Sven-Olof leaves for Baltimore 906 at 10:15 a.m., in accordance with the information displayed on Madeleine's user device 102-x and passes through Baltimore 906. Madeleine's user device 102-x continues to provide suggestions for alternate paths and/or optimal times at different points during the trip.

Assume that as an accident occurs near Wilmington 908. As Madeleine, Kristian, and Sven-Olof approach Wilmington 908, user device 102-x makes a request to server device 106 for an optimal path/travel times. Based on updated traffic information, server device 106 determines that taking current path may cause Madeleine to spend 1 hour from point 910 to Philadelphia 904 and an alternate route 912 only 35 minutes. Server device 106 sends the information to user device 102-x, which relays the information to Madeleine. Madeleine, Kristian, and Sven-Olof continues on their way to Philadelphia 904 via alternate route 912.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in the above, user device 102-x/server device 106 may use either the current or past traffic data to determine optimal starting times for a trip. In some implementations, user device 102-x/server device 106 may use a combination of both the current and past data. For example, server device 106 may use the current data for estimating the amount of time the user may take to travel areas that are close to user device 102-x.

In another example, in the above, while series of blocks have been described with regard to the exemplary processes illustrated in FIGS. 8 and 9, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving a request, from a user device, to determine optimal starting times for a trip;
obtaining a destination address and a starting address of the trip from the request;
identifying a first route based on the destination address and the starting address;
determining the optimal starting times based on different allowable starting times and travel data, the determined optimal starting times providing for a shortest estimated travel time on the first route; and
sending a description of the first route and the determined optimal starting time to the user device.

2. The method of claim 1, wherein determining the optimal starting times includes:
identifying portions of the route;
obtaining traffic information for each of the portions;
determining a travel time for each of the portions based on the traffic information; and
calculating a total travel time for the route based on the determined travel times for the portions.

3. The method of claim 2, wherein obtaining the traffic information includes:
performing a lookup of the traffic information in a database for each of the portions; or
requesting and receiving the traffic information for the portions from a remote device.

4. The method of claim 3, wherein performing the lookup includes:
performing a lookup of past speeds of vehicles on one of the portions based on time information, weather information, and locality information.

5. The method of claim 4, wherein performing the lookup of past speeds of vehicles on the portion based on time information includes:
performing a lookup of past speeds of vehicles on the portion based on time of day and none or more of: day of week, day of month, or month of year.

6. The method of claim 1, further comprising:
receiving traffic data from user devices and storing the traffic data, weather information, and locality information.

7. The method of claim 1, further comprising:
determining an alternate route when the calculated total time exceeds an average travel time by a particular amount; and
determining, based on other travel data and the allowable starting times, a starting time that provides a shortest estimated travel time on the alternate route.

8. The method of claim 1, wherein the travel data includes:
past location, time, and speed information for the user device.

9. The method of claim 1, wherein determining travel time for each of the portions based on the traffic information includes:
scheduling a departure time for the trip.

10. A device comprising:
a network interface for communicating with a remote device; and
a processor configured to:
receive user input that specifies a time window for starting a trip;
communicate, to the remote device, a request for information pertaining to the trip;
receive the information from the remote device;
identify, based on the information, a starting time that is in the time window and provides for a shortest estimated travel time; and
output, to the user, information conveying the starting time.

11. The device of claim 10, wherein the time window includes:
a time window for completing the trip.

12. The device of claim 10, wherein the device includes:
a cell phone or a personal digital assistant.

13. The device of claim 10, further comprising:
a navigational component configured to obtain locations of the device.

14. The device of claim 13, wherein the processor is further configured to:
send a description of the locations of the device to a traffic device when an average traveling speed of the device exceeds a particular threshold.

15. The device of claim 13, wherein the processor is further configured to:
send a description of the locations of the device from within a moving vehicle.

16. The device of claim 13, wherein the navigational components include at least one of:
a global positioning system (GPS) receiver; an accelerometer; a magnetometer; or a gyroscope; a component for locating the device based on Wi-Fi; or a component for locating the device based on Global System for Mobile Communications (GSM).

17. The device of claim 10, wherein the processor is further configured to:
determine an alternate route when a current estimated time of travel exceeds an average travel time by a particular amount.

18. The device of claim 10, wherein the processor is further configured to:
obtain past travel times for the route from the remote device.

19. The device of claim 10, wherein the information includes:
travel data; or
a description of the starting time and a travel time associated with the starting time.

20. A device comprising:
a processor configured to:
receive, from a user device, a request to determine optimal starting times for a trip;
identify a route that is associated with the trip;
estimate, based on travel data and different allowable starting times specified in the request, a shortest travel time; and
send a description of a starting time that is associated with the shortest travel time to the user device.
